(19) United States
(12) Patent Application Publication
(10) Pub. No.: US 2017/0001487 A1
(43) Pub. Date: Jan. 5, 2017

(54) Tension sources and stabilizers with modified roll on method for mounting tire chains

(71) Applicant: Ray R. Miller, Lakewood, WA (US)

(72) Inventor: Ray R. Miller, Lakewood, WA (US)

(21) Appl. No.: 14/545,893

(22) Filed: Jul. 2, 2015

(51) Int. Cl. B60C 27/12

(52) U.S. Cl. CPC B60C 27/12

(57) ABSTRACT

A method of mounting a vehicle tire chain on a vehicle tire by draping the chain on the tire and connecting the free ends of the chain with suitable temporary straps to form temporary loops on the tire and rolling the wheel a quarter to a half of a revolution to complete the mounting of the chain, and producing a high quality mounting using special tension sources and stabilizers to migrate residual chain slack to the side chain closure device during a short travel to a stop to re-hook the chain to a suitable operating chain tension.

### CROSS REFERENCES TO RELATED APPLICATIONS:

This is a continuation of application Ser. No. 13/261,811 filed Feb. 10, 2014, now abandoned.

PCT US2011/001679 FILED Sep. 29, 2011

U.S. Ser. No. 13/261,811 FILED Feb. 10, 2014

PPA Ser. No. 62/122,311 FILED Oct. 17, 2014

### FEDERALLY SPONSORED RESEARCH

Not Applicable

### SEQUENCE LISTING OR PROGRAM

Not Applicable

### BACKGROUND OF THE INVENTION

Field of the Invention

This invention generally relates to vehicle tire chains, specifically mounting highway truck tire chains, for improved mounting performance.

Prior Art

The industry standard for heavy highway truck tire chains, since the early nineteen hundreds, is link construction, ladder pattern, tire chains, mounted tuck-in/roll-on method.

The present disclosure includes a distinct modification of the tuck-in/roll-on method, and also has strong advantages over the mounting-about-the-tire-footprint method mentioned below.

Recent activity, in this subject, includes PCT/US2011/01679, titled Tire Chain Tension Sources and Stabilizers, filed Sep. 29, 2011, with PCT national applications in US and Canada, and in combination with the tire chain of U.S. Pat. No. 8,162,017, as a known art tire chain.

PCT 1679 and the two national applications are based primarily on a chain mounting method of mounting about-the-tire-footprint.

PCT 1679 provides a significant advance in tire chain mounting performance with an innovative tension source and stabilizer combination, for use on a chain mounted in a mount-about-the-tire-footprint, as described in U.S. Pat. No. 8,162,017, to provide reduced travel after mounting, to achieve a taut, slack free chain.

### SUMMARY OF THE INVENTION

### Objects and Advantages

The objective of the present disclosure is to provide a new, distinctive modification of the standard practice tuck-in/roll-On chain mounting, in combination with the innovative tension source/stabilizer combination of PCT 1679, for the following objectives and advantages:

Provide roll-on mounting immunity to truck loading variation of impact on tire footprint, without the high chain slack created by current practice tuck-in/roll-on mounting.

Avoid the US 017 step of extensive shifting of the chain, draped on the tire, for mounting, to fasten the rear face side chain into a loop on the tire, while simultaneously avoiding sensitivity to truck loading, as in US 017.

The net result of present disclosure is a further decrease in required travel, after chain mounting, to achieve a taut, slack free tire chain, for operation, beyond the decrease provided by PCT 1679, and a reduction in mounting effort for heavy, highway truck chains.

The specific change in mounting method is to delete tuck-in of the chain, to make the required quarter turn of the wheel, to mount the chain, and instead, to use temporary connector means, between chain ends, to enable the required partial turn of the wheel. The net result of the disclosure is to enable mounting of chains, achieving a condition of taut chains, controlled by steel (non elastic), at the designated chain up location, before returning to the highway to continue travel.

The present invention involves using temporary connector lines, from the short end of the chain, draped on the tire, to the long, or trailing end of the chain, and manually aligning the cross chains on the tire tread, to minimize chain slack, so the chain can be drawn around the tire, by rotation of the wheel, without the current general practice of tucking the chain under the tire, to make the rotation of the wheel, as above, thereby creating excessive chain slack, due to misalignment of cross chains on the tread.

An objective of the present invention is to provide an alternative chain mounting method, to the method of PCT 1679, for using the tension sources and stabilizers of PCT 1679, taking forward both the existing application, as in those documents, and the present invention, for commercial use, making both alternative mounting methods available to the user, according to his chain usage needs and preferences. The modified roll-on method disclosed here, is the preferred mounting method, for larger trucks.

### Advantages of the Present Invention vs PCT 1679 Mounting Method

These advantages are:
Reduced mounting effort for large, heavy chains.
Increased user prior familiarity with the mounting method (roll on).
No sensitivity to truck loading level for the present disclosure method.
No twisting of the full chain while draping on the wheel, in order to attach the rear face side chain into a loop on the wheel.
Easier to achieve problem free mounting on shoulder traction. features.

Disadvantages of present disclosure vs PCT1679 are:
Requires a quarter turn of the wheel to complete the mount.
Small residual chain slack may remain at two stops (after quarter turn).

There is no difference between present disclosure and the “mount about the tire footprint” of PCT 1679 for these features:
Identifying and controlling optimum operating tension, for wear.
Eliminate cam tighteners on the basic chain.

### BRIEF DESCRIPTIONS OF THE DRAWINGS

FIG. 1 Draping the chain on the wheel.

FIGS. 1A, 1B Connecting the rear face temporary connector.

FIG. 2 Schematic plan of the chain.

FIG. 3 Connecting outer face temporary connector.

FIG. 4 Finishing the chain mount for operation.

FIG. 5, 6, 7 Alternative configurations of the tension source/stabilizer.
FIG. 5 One tension element, one stabilizer element.
FIG. 6 Two tension elements, two stabilizer elements.
FIG. 7 One tension element, two crossed stabilizer elements.

### DETAILED DESCRIPTIONS OF THE DRAWINGS

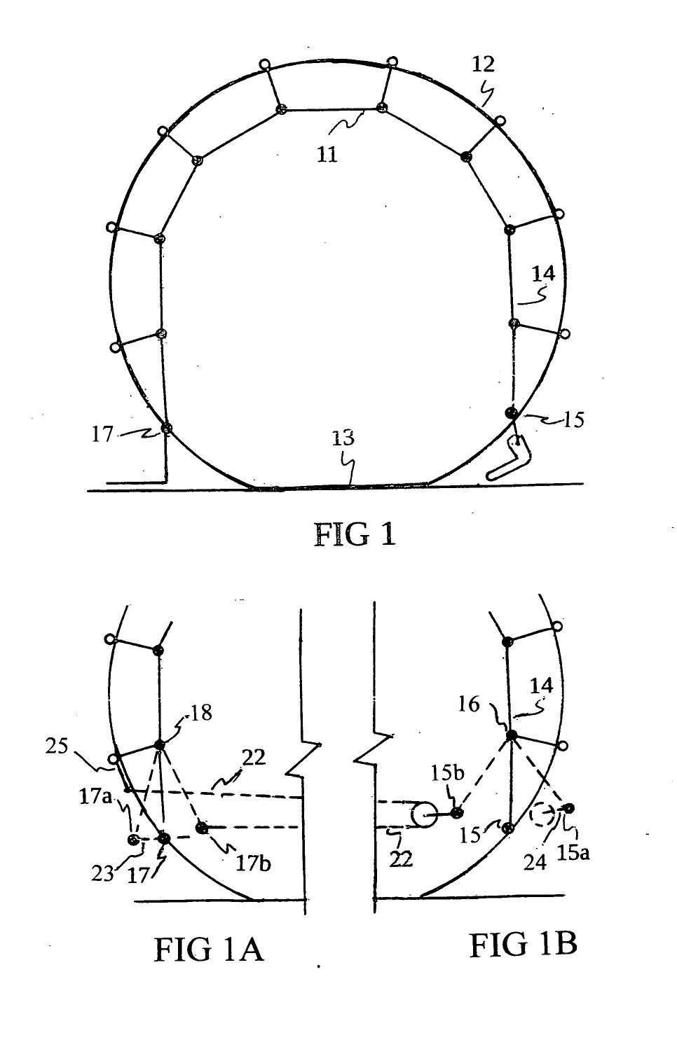

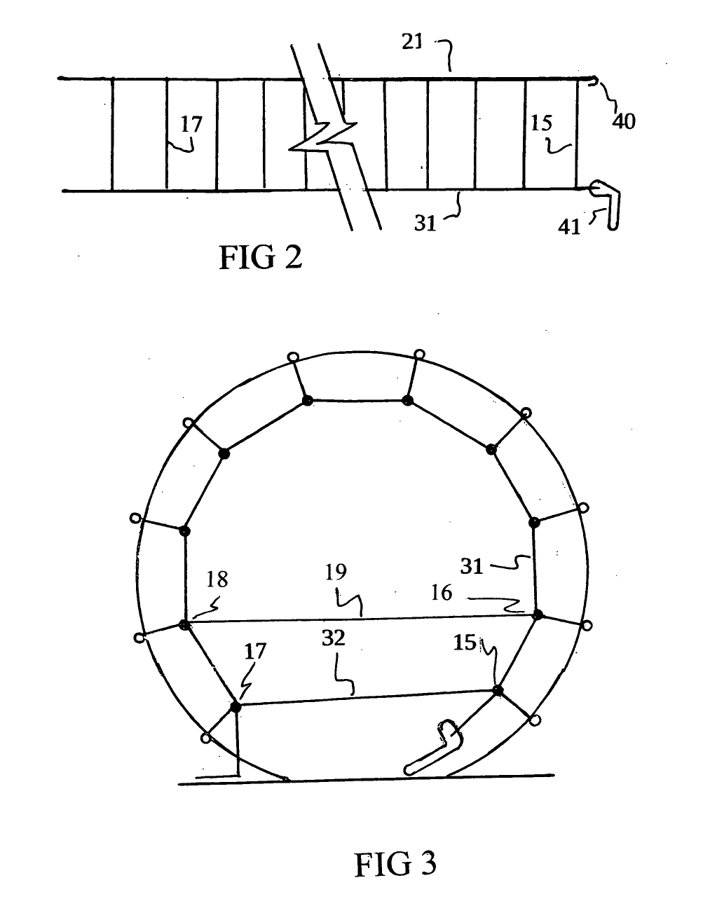

FIG. 1 shows the tire chain 11 draped over the tire 12 with the chain right end 14 chosen to be the “short end” such that the end (lowest) cross chain 15 connection to side chains 21 and 31 in FIG. 2 is at approximately 45 degree angle down from the wheel center point, either right or left. Shown to the right in FIG. 1.

FIG. 2 displays a plan view of the tire chain to show positions of cross chains 15 and 17, rear face side chain 21 and closure device 40, outer face side chain 31 and closure device 41, all as shown in other FIGS. 1 to 4.

FIGS. 1A and 1B display a temporary non-elastic strap or chain connector 22 in position on rear face side chain. 21, in position to enable a partial turn of the wheel, to finish mounting the tire chain on the tire. In FIG. 1A, installation of connector 22 begins with holding side chain 21 in clear view, to attach first end of connector 22, fitted with hook 23, to the attachment link of cross chain to rear face side chain 21, at position 17a.

In FIG. 1B, connector 22 is passed behind the tire to enable attachment of free running pulley, fitted with hook 24, to attach to attachment link of lowest cross chain 15 to side chain 21, all held in the clear view for attachment.

Second end of connector 22 is used to pull connector 22 and side chain 21 into normal operating positions, shown as cross chain positions 15b and 17b.

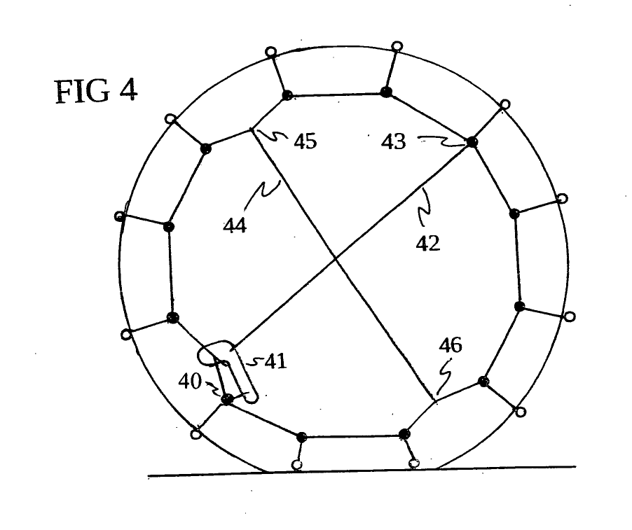

At this point, in FIG. 3, cross chains 16 and 18 and all higher level cross chains are manually aligned on the tire tread, into their natural operating positions.

In FIG. 1A, the second end of connector 22 is passed around the corner of the tire tread between cross chains 17 and 18 and hooked into cross chain 18 on the tread surface. Hook 25 is relocated on connector 22 to suit the hooking location.

In FIG. 3, elastic temporary connector 32 is hooked into position on outer face side chain 31, at cross chain positions 15 and 17, adjusting the length of connector 32 as needed, for fully applied tension to result in hooking into a side link chain coming from the cross chain. 17.

It can be readily observed, that the non-elastic nature of temporary connector 22, as elastic, and connector 32 as non-elastic, could be easily reversed. That is, provide connector 22 as elastic, and connector 32 as non-elastic. The determining factor to be making connector 22 as simple as possible, because of its inconvenient access.

The wheel is turned a quarter to a half revolution, as desired, turning into the chain short end.

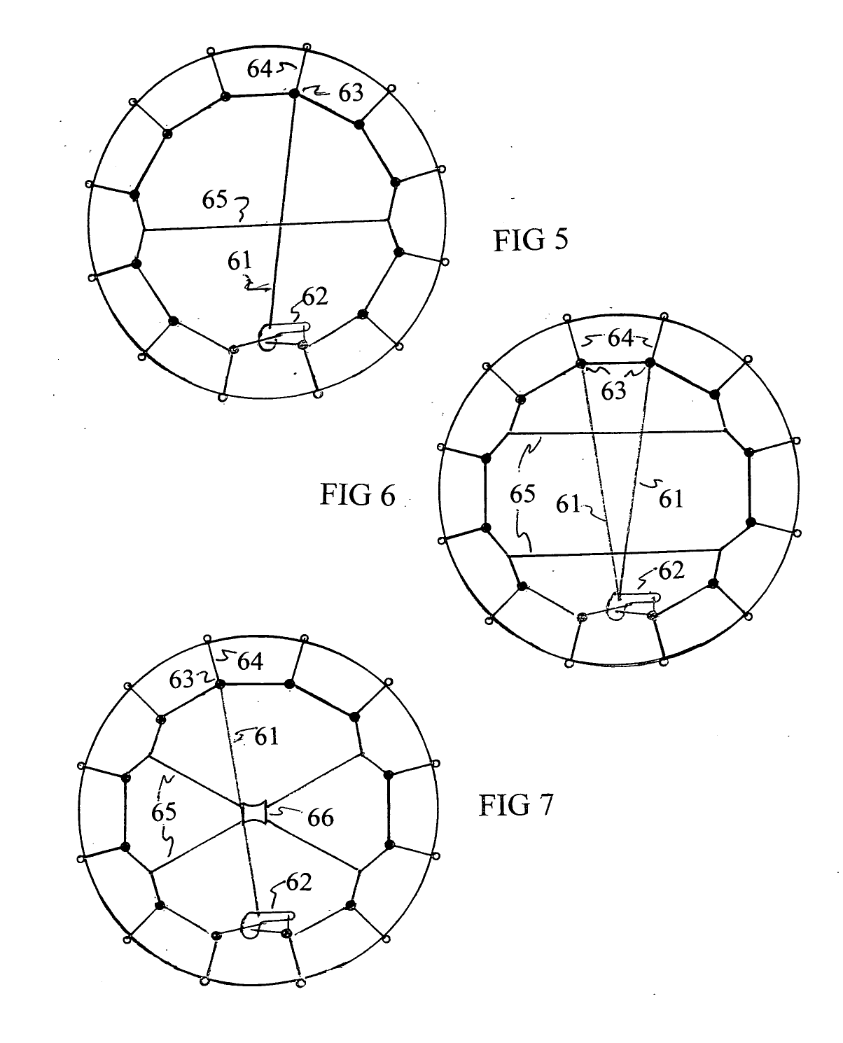

FIG. 4 shows the outer face side chain closure device 41in a closed condition, following the turn of the wheel. Before closure of device 41, the rear face side chain is connected into a loop on the rear face of the tire, at a preselected, known loop length, to suit the desired chain fit to the tire, using closure device 40. Then, the temporary connector 22 is removed.

Open face closure device 41 is fastened, temporarily, at a moderate chain tension suitable to facilitate the alignment of remaining cross chains, on the tread, as needed. That step is performed.

After alignment of cross chains, closure device 41 is fastened to a manually tight chain tension.

Following closure of the side chain closure device 41, a non-elastic steel stabilizer chain or chains 44 are hooked to the side chain segment midpoints, as at 45 and 46, the chain(s) at approximate center of the outer face, and at right angles to the tension source location.

A tension source, one or more elastic strap(s) 42 are hooked at closure device 41, and hooked diametrically opposite on the outer face side chain, at side chain link 43, which is an attachment point for a cross chain. Elastic strap 42 will have elastic properties of preselected specifications, according to size and capacity of the tire chain. The specifications will be of an order of magnitude of: stretch of 50 to 100 percent, and maximum tension capacity of 20 to 30 pounds tension, hooked in place.

The chain is then ready for initial travel.

FIGS. 5, 6 and 7 display alternative configurations for the tensioning mechanism comprising a tension source section and a stabilizer section.

In all of FIGS. 5, 6 and 7, elastic tension source straps 61, having a hook at each end, have a first end attached at the outer face side chain segment containing the side chain closure device 62, of an initially mounted tire chain. The second end of each tension source strap 61 is always attached at a diametrically opposite point of the side chain, at a link which is an attachment link 63 for a cross chain 64.

Non-elastic stabilizer straps 65 (usually a steel chain) have a hook at each end, and are attached at midpoints 66 of side chain segments, long enough to double back on themselves, at one end, to select the desired length in the chosen location.

The installed length chosen will be the length which, in the judgment of the user, produces the desired radially inward angle from a straight line normal position of the segment to which attached. This will usually be roughly 10 degrees deflection from a straight line segment.

The stabilizer chains are attached in parallel or crossed, if more than one, and the stabilizer section, whether one or more stabilizer straps or chains, will be installed at a ninety degree orientation to the tension source section. In FIG. 7, crossed stabilizer chains can optionally be passed through a loose fitting section of rubber hose 66, if preferred.

Tension source section connections and stabilizer chain connections will not be overlapped or intermingled, as that would not allow the primary function of the combination, which is to automatically migrate residual chain slack, from the mounted chain, to the chain segment containing the side chain closure device 62, from the right and from the left.

This function happens automatically upon travel of the vehicle for a few yards, aided by the absence of friction caused by passage of the tire and chain through the zone of contact with the roadway.

### Optional Mounting Techniques and Procedures

The instant disclosure of chain mounting, utilizing the combination of an innovative mounting method and an innovative tension source and stabilizer combination, provides an unprecedented flexibility of hardware and techniques to suit a wide range of highway truck tires and chains, from smaller delivery trucks to the largest trucks legal for normal travel on the highways. The flexible hardware and preferred mounting techniques of the user/operator enable variations such as the following.

A) A mounted tire chain, tight enough at initial mounting, as at FIG. 4, to travel to a first planned stop in the route, to then check chain tightness for suitability for further travel, or unhooking and re-hooking at a chain tension condition. In pursuing that objective, manual alignment of cross chains, and placement of stabilizer chains, would be aggressively pursued, toward the objective.

B) Alternatively, cross chain alignment and stabilizer placement could be much less aggressive, and the initially installed chain could be driven a few yards to allow automatic migration of residual chain slack to facilitate the desired unhooking and re-hooking to a tight chain. Two to three revolutions of the wheel, for about twenty to thirty feet of travel, should produce the desired tight chain results.

C) A further refinement, made possible by the unique properties of the mounting disclosure, is mounting the chain on a tire having traction features designed into the shoulders of the tire on which the chain is mounted, which permit full seating of all cross chains into those shoulder features, during mounting. This unique feature aids the user to easily achieve alignment of cross chains, on the tread, to minimize chain slack and increase stability of the mounted chain. The interior tread, between shoulders, is immaterial. The shoulder traction features provide the dual benefits of aid to chain mounting and aid to vehicle traction.

### Mounting Method and Tightening Mechanism in Combination

The combinations disclosed can perform several functions not possible today by other technology, including:
Far more flexible and adaptable to the trucking conditions (long haul, short haul, delivery, etc).
Can mount on all high traction tires problem free.
Can consistently get to a desired tension level for operation, with less travel after mounting, than other known technologies..

### Inventive Steps of the Disclosure

### Tension Source and Stabilizer Combinations

The primary objective of the tension source and stabilizer combination is to automatically migrate all residual chain slack from an initially mounted tire chain, directly to the side chain closure device, for easy re-hooking to a desired level of chain tension, regarding chain wear and tire sidewall wear.

The migration of chain slack occurs rapidly with travel, due to the absence of friction when the tire passes through the zone of contact with the roadway.

The disclosed tensioning mechanism is especially useful for two types of chain mounting systems for link construction tire chains:
A mounting system of “mount about the tire footprint”, as in US 017, which concentrates the chain slack at the side chain closure device, and enables mounting steps to align cross chains to reduce random chain slack.
A system of modified roll-on disclosed herein, to provide mounting insensitive to variation of the tire footprint, with truck loading.

### Modified Roll-On Mounting

The inventive step for the Modified Roll-On mounting method is to eliminate tuck-in mounting, to obtain the insensitivity to truck loading level, of roll-on, by temporarily connecting chain ends, with temporary connectors, to make the partial turn of the wheel, to connect the chain ends.

A further benefit of the method is the absence of forced movement of chain on tread, extensive with tuck-in, which enables problem free mounting of chains with aggressive tread, in distinct contrast to current and historic tuck-in mounting.

The specific nature of the temporary connectors needed to practice the concept, is not claimed in the inventive step. Several alternative configurations are displayed. None are claimed as inventive step or even best embodiment. User preferred technique and alternative may prove to be different between light trucks for local delivery and four to six axle and larger trucks at the top of the size spectrum, including wide base single tires, for dual replacement.

What is claimed as the inventive step is the use of temporary connectors to connect chain ends to make the required partial turn of the wheel to complete a roll-on chain mounting, with complete elimination of tuck-in mounting and cam tighteners to enable and provide:
Insensitivity to truck loading effect on the tire footprint.
Minimum chain slack in mounting.
Minimum chain movement on tread, for trouble free mounting of aggressive tread tires.
Effective use of the claimed tension source/stabilizer combination, for chain slack control.
   The problem free mounting on aggressive tread tires is a distinct advantage to both chain usage and tire usage.

### Combined Effect of Tensioning Mechanisms and Modified Roll-On Mounting

While each separate disclosure includes inventive step, only the two disclosures combined, enable a great reduction of required travel to achieve a suitable chain tension for highway travel, down to a few yards of travel, using the present disclosure. This, compared to potentially miles of travel with tuck-in/roll-on, to achieve the same objective. This means that vehicles can now achieve full desired chain tension, of road in the chain up area, before returning to the highway.

I claim:

1. A method of mounting a link construction, ladder pattern, vehicle tire chain, comprising a pivot lever style outer face closure device, the method comprising the steps of
a. draping said chain over the tire, leaving the last cross chain, on one end of the chain, which will be the short end, at roughly a forty five degree angle down from the wheel center point, right or left, and
b. aligning manually all cross chains, which are at, or higher than, the center point of the wheel, to their natural operating positions on the tread, and placing a temporary elastic strap to maintain alignment, and
c. using suitable temporary connecting means to connect the short, leading end of the draped chain and the longer, trailing end of the chain, and
d. driving the wheel about a quarter to a half of a revolution toward the short, leading end of the chain, and
e. fastening the rear face side chain into a loop on the tire, at a preselected loop length, to suit the desired fit of chain to tire, and
f. removing said temporary connecting means from the short and long ends of the chain, and
g. temporarily fastening the open face closure device to form a loop on the tire, at a chain tension suitable for manually adjusting the alignment of remaining cross chains, as required, into their natural operating positions, and performing said adjustment, and
h. re-hooking said outer face closure device into a manually available chain tension, and
i. attaching one or more non-elastic stabilizer chains, at the center of selected segments of the outer face side chain, substantially at the center of the outer face of the chain, and at substantially right angles to the tension source elastic straps, and selecting lengths for the fully attached stabilizer chains which will deflect the attachment points of the stabilizer chain radially inward, from a straight line of the segment, a distance judgmentally appropriate to the angle of deflection of the side chain from a straight line, and
j. attaching one or more tension source elastic straps into the outer face side chain segment containing the closure device, and fastening the opposite ends of said elastic straps at points diametrically opposite said closure device, into side chain links which are attachment points for a cross chain, to the side chain, at a preselected tension level of the elastic strap, and
k. beginning initial operation, which, in the judgment of the operator, based on chain tension and the planned trip, will either be proceeding on the planned trip, or driving a few yards to a re-hooking to a suitable chain tension.

2. The method of claim 1 for mounting a vehicle tire chain, in which using said suitable temporary connecting means to connect the two ends of the tire chain, draped on the tire, comprises the steps of
a. providing a temporary non-elastic connector, with hook at each end, and passing said temporary connector around a pulley fitted with a hook for the far side, and
b. deflecting the long, trailing end of the rear face side chain to be clear of the tire for visibility, and
c. hooking said temporary connector into the rear face side chain link which is a connection for the cross chain nearest in level to the lowest cross chain on the short, leading end, and
d. passing the temporary connector behind the tire, and
e. attaching the temporary connector, in a location of clear visibility, to the connection of lowest cross chain to the side chain, short end, by means of the hook on the mid length pulley, and
f. returning the rear face side chain to its natural operating position by pulling the second end of the temporary connector, and using a short elastic hooked strap to attach the temporary connector to the next higher cross chain on the tread, and
g. providing a temporary elastic connector strap for installation on the outer face side chain, with dimensions and elastic properties to suit an installed position essentially matching the alignment of the first span of the rear face temporary connector, of length to use free links projecting from the cross chains connected to the rear face temporary connector, and
h. installing said elastic connector strap onto the outer face side chain parallel to the temporary connector on the rear face side chain.

3. A tire chain tightening mechanism comprised of a tension source section and a stabilizer section, for use on a vehicle tire chain mounted on a tire, and said tire chain is of link construction, ladder pattern for highway use, and
the tire chain comprises a pivot lever style outer face side chain closure device, and
said tension source section comprises one or more elastic tension members, each having a first end, manually fastenable to the outer face side chain, at or near said side chain closure device, and
the opposite, second ends of said tension members are attached under tension to the outer face side chain, diametrically opposite the side chain closure device, and each tension member is attached to a chain link which is an attachment link for a cross chain, and
said stabilizer section comprises one or more members of flexible, non-elastic steel, each manually attachable to opposite sides of the outer face side chain, at midpoints of segments of side chain, between side chain connections, and
the stabilizer section and the tension source section are generally oriented at right angles to each other, with the connection zones of the two sections, to the side chain, not overlapping or intermixed, and
the tension from the tension source section, and the interaction of the interconnected chain parts places the stabilizer section under tension, and
during initial travel from mounting the chain on the tire, the combination of tension source and stabilizer act to migrate residual chain slack from mounting the chain on the tire, to the location of the side chain closure device, whereby
the vehicle can be stopped for an easy unhooking and re-hooking of the closure device and tension source, to a desired chain tension level suitable for continued travel.

4. Using the method of claim 1 for mounting a tire chain on a tire, to mount a tire chain on a tire having shoulder traction features arranged in a manner permitting full seating of cross chains in said shoulder traction features.

5. Using the method of claim 1 for mounting a tire chain on a tire, to mount a tire chain on a wide base tire which is a single tire for replacing duals.

6. Using the method of claim 1 for mounting a tire chain on a tire, for which said tire chain is a two rail dual mount chain, on which the cross chains span both dual tires of a set of dual tires.
